(19) United States
(12) Patent Application Publication
(10) Pub. No.: US 2026/0240331 A1
(43) Pub. Date: Aug. 20, 2026

(54) REINFORCING BRACE STRUCTURE FOR FURNITURE FRAME

(71) Applicants: Anji Longwin Consulting Management Co., Ltd., Huzhou (CN); Houbin Xie, Ningbo (CN)

(72) Inventors: Chen DING, Huzhou (CN); Tianyu Huang, Huzhou (CN); Peixia Chen, Huzhou (CN); Chenfeng Cai, Huzhou (CN); Houbin Xie, Ningbo (CN)

(73) Assignees: Houbin Xie, Ningbo (CN); Anji Longwin Consulting Management Co., Ltd., Huzhou (CN)

(21) Appl. No.: 19/646,632

(22) Filed: Apr. 14, 2026

Related U.S. Application Data
(63) Continuation-in-part of application No. PCT/CN2024/094191, filed on May 20, 2024.

(30) Foreign Application Priority Data
Apr. 19, 2024 (CN) 202410474512.5
Apr. 19, 2024 (CN) 202420819211.7

(51) Int. Cl. A47C 17/86; F16B 12/50

(52) U.S. Cl. CPC A47C 17/86; F16B 12/50

(57) ABSTRACT

A reinforcing brace structure for a furniture frame belongs to the technical field of furniture structures. The reinforcing brace structure includes a tube body, a lower slot, and an inverted L-shaped slot unit. The reinforcing brace structure enables the use of a tube body with a relatively large vertical dimension together with an inverted L-shaped slot unit having a relatively shallow vertical cut depth, thereby ensuring high structural strength of the reinforcing brace; The vertical cut depth of the inverted L-shaped slot unit is less than the vertical height of the side plate of the side longitudinal beam or intermediate longitudinal beam, leaving a residual vertical plate portion of the beam below the inverted L-shaped slot unit that engages with the lower slot. This engagement prevents the longitudinal beams from splaying apart and effectively inhibits the tube body from falling out.

### CROSS-REFERENCE TO THE RELATED APPLICATIONS

This application is the continuation-in-part application of International Application No. PCT/CN2024/094191, filed on May 20, 2024, which is based upon and claims priority to Chinese Patent Applications No. 202420819211.7 and No. 202410474512.5, both filed on April 19, 2024, the entire contents of which are incorporated herein by reference.

### TECHNICAL FIELD

The present application relates to the technical field of furniture structures, and particularly to a reinforcing brace structure for a furniture frame.

### BACKGROUND

Conventional bed frames and sofa frames typically include support legs, side rails, intermediate panels, and reinforcing braces. For single beds and sofas with relatively small widths, the intermediate panel is generally a single member, and the length of the reinforcing brace corresponds to the width of the frame.

For double beds with larger widths, the intermediate panel is usually shaped as a cross. In such cases, the length of the reinforcing brace may be equal to the full width of the frame or half of the frame width. The term “reinforcing brace” referred to herein specifically denotes this reinforcing cross member.

Moreover, all of the aforementioned “panel” components may be replaced with rectangular tube structures, resulting in a steel frame furniture assembly.

For example, Chinese Utility Model Patent No. CN211533542U, published on September 22, 2020, discloses a portable modular bed frame including two frame-type support frames and a bed panel frame. The bed panel frame includes two side longitudinal beams and multiple transverse beams. Each side longitudinal beam includes two longitudinal beam units and a first support foot. The upper end of the first support foot is provided with a first connecting recess. One end of each longitudinal beam unit is fastened to the support frame via a first bolt, while the other end is secured within the first connecting recess by a second bolt and a second nut. The longitudinal beam units are hollow rectangular tubes, and multiple mounting openings are formed at intervals along the inner upper side thereof. The ends of the transverse beams are inserted into these mounting openings, and elastic cushioning members are disposed at the joints between the transverse beams and the mounting openings.

The modular bed frame disclosed in this utility model offers advantages such as simple and convenient assembly and disassembly, ease of portability, and good flexibility.

However, during actual use, this modular bed frame still suffers from at least the following two shortcomings, which also represent the technical problems addressed by the present application:

First, the transverse beam—which corresponds to the aforementioned reinforcing brace—is installed by being inserted into a mounting opening. Therefore, if the vertical dimension of the transverse beam is relatively large, the depth of the mounting opening must also be increased accordingly, which compromises the structural strength of the side longitudinal beam. Conversely, if the mounting opening is shallow, only transverse beams with smaller vertical dimensions can be used, which in turn results in insufficient structural strength of the beam itself—a clear structural deficiency.

Second, the transverse beam lacks any longitudinal (lengthwise) retention mechanism within the mounting opening. In other words, if the two side longitudinal beams deform and move apart from each other, the transverse beam may easily fall out, posing a significant safety hazard.

In summary, there is an urgent need for a novel reinforcing brace structure featuring a more efficient and safer end-connection mechanism, suitable for various types of knock-down steel furniture frames.

Although the reinforcing brace structure disclosed in the aforementioned International Patent Application No. PCT/CN2024/094191 provides relatively high connection strength and notable ease of installation, it still exhibits certain practical limitations in real-world use. Specifically, under harsh operating conditions—such as severe shaking—the connection structure remains prone to unintentional detachment.

Building upon this foundation, the present application further optimizes the reinforcing brace structure by introducing new mating configurations and additional reinforcement locations, thereby significantly enhancing both the connection strength and installation convenience of the reinforcing brace.

### SUMMARY

The present application provides a reinforcing brace structure for a furniture frame. The structure includes a tube body (11), a lower slot (100), and an inverted L-shaped slot unit (200), thereby achieving the following: (1) The reinforcing brace structure enables the use of a tube body (11) with a relatively large vertical dimension in conjunction with an inverted L-shaped slot unit (200) having a relatively shallow vertical depth, ensuring high structural strength of the reinforcing brace; (2) The vertical depth of the inverted L-shaped slot unit (200) is less than the vertical dimension of the side plates of the side longitudinal beam (12) and the intermediate longitudinal beam (13). The portion of the longitudinal beam located below the inverted L-shaped slot unit (200) engages with the lower slot (100), preventing the longitudinal beams from spreading apart and thus inhibiting the tube body (11) from falling out.

To solve the aforementioned problems, the present application adopts the following technical solution: A reinforcing brace structure for a furniture frame, including a tube body (11), at least one lower slot (100) formed on the bottom plate and two side plates of the tube body (11) at an end thereof, and an inverted L-shaped slot unit (200) provided on the top plate and side plate(s) of the side longitudinal beam (12) and/or the intermediate longitudinal beam (13) for engaging with the lower slot (100).

In a further preferred embodiment, the structure further includes an oblique-cut latch block unit (300) provided at the end face of the tube body (11), and an opening (400) formed on the side plate(s) of the side longitudinal beam (12) and/or the intermediate longitudinal beam (13) for receiving the oblique-cut latch block unit (300).

In a further preferred embodiment, the inverted L-shaped slot unit (200) includes a two-surface slot (201) configured to receive the end of the tube body (11) from both horizontal and vertical directions.

In a further preferred embodiment, the inverted L-shaped slot unit (200) further includes a retaining plate (202) provided on the horizontal bottom surface of the two-surface slot (201) and inserted into the lower slot (100).

In a further preferred embodiment, the vertical side surface of the retaining plate (202) is positioned against the inner side surface of the tube body (11).

In a further preferred embodiment, the upper surface of the retaining plate (202) is positioned against the inner top surface of the tube body (11).

In a further preferred embodiment, the oblique-cut latch block unit (300) includes a U-shaped block (301) mounted on the end face of the tube body (11), and an offset oblique-cut (302) provided on the upper surface of the U-shaped block (301) for enabling inclined insertion of the tube body (11) into the opening (400).

In a further preferred embodiment, the opening (400) is formed on the side plate of the side longitudinal beam (12) or the intermediate longitudinal beam (13).

In a further preferred embodiment, the inverted L-shaped slot units (200) are provided in pairs on the intermediate longitudinal beam (13).

In a further preferred embodiment, each pair of inverted L-shaped slot units (200) penetrates through the top plate of the intermediate longitudinal beam (13).

In a further preferred embodiment, a vertical clearance (20) is defined between the upper surface of the retaining plate (202) and the inner top surface of the tube body (11).

In a further preferred embodiment, a lateral clearance (21) is defined between the vertical side surface of the retaining plate (202) and the inner side surface of the tube body (11).

In a further preferred embodiment, the two opposing side surfaces of the lower slot (100) are respectively positioned on the vertical plate regions of the side longitudinal beam (12) and/or the intermediate longitudinal beam (13) located below the two-surface slot (201).

In a further preferred embodiment, the furniture frame is a sofa.

In a further preferred embodiment, the sofa further includes side cross beams (14) and the side longitudinal beams (12), which together form a sofa seat frame.

In a further preferred embodiment, the number of sofa seat frames is two or more.

In a further preferred embodiment, the sofa further includes L-shaped connecting plates (22) mounted on the lower surfaces of the side cross beams (14) or side longitudinal beams (12) for hooking and connecting adjacent sofa seat frames. The L-shaped connecting plates (22) interconnect adjacent sofa seat frames into an integral assembly, thereby reducing the required connection strength at the joint between the lower slot (100) and the inverted L-shaped slot unit (200).

In a further preferred embodiment, the sofa further includes corner-reinforcing cross plates (23) mounted on the sofa seat frames for connecting adjacent side cross beams (14) and side longitudinal beams (12).

In a further preferred embodiment, the horizontal flange of the L-shaped connecting plate (22) and/or the corner-reinforcing cross plate (23) is provided with threaded holes (24), and sofa support legs (25) are mounted in the threaded holes (24).

In a further preferred embodiment, auxiliary reinforcement threaded holes (27) aligned with the threaded holes (24) are further provided on the lower surfaces of the side cross beams (14) or side longitudinal beams (12), cooperating with the threaded holes (24) to mount support leg bolts (26).

### BRIEF DESCRIPTION OF THE DRAWINGS

FIG. 1 is a schematic view illustrating a first usage mode of the present application.

FIG. 2 is a schematic view illustrating a second usage mode of the present application.

FIG. 3 is a schematic view illustrating an installation configuration of the tube body (11) on the intermediate longitudinal beam (13).

FIG. 4 is a schematic view illustrating the position and shape of the lower slot (100).

FIG. 5 is a schematic view illustrating the position and structure of the inverted L-shaped slot unit (200).

FIG. 6 is a schematic view illustrating a paired arrangement of the inverted L-shaped slot units (200).

FIG. 7 is a schematic view illustrating the position and structure of the oblique-cut latch block unit (300).

FIG. 8 is a schematic view illustrating one exemplary position of the opening (400).

FIG. 9 is a schematic view illustrating the position and shape of the offset oblique-cut (302).

FIG. 10 is a schematic view illustrating the structure of the L-shaped cutout tab (16) corresponding to the retaining plate (202).

FIG. 11 is a schematic view illustrating the positions of the vertical clearance (20) and the lateral clearance (21).

FIG. 12 is a schematic view illustrating a bidirectional retention engagement configuration of the lower slot (100).

FIG. 13 is a schematic view illustrating one exemplary structure of the sofa seat frame.

FIG. 14 is a schematic view illustrating the position and shape of the L-shaped connecting plate (22).

FIG. 15 is a schematic view illustrating a hook-type connection configuration of the L-shaped connecting plate (22).

FIG. 16 is a schematic view illustrating the position and shape of the corner-reinforcing cross plate (23).

FIG. 17 is a schematic view illustrating one exemplary shape of the sofa support leg (25).

FIG. 18 is a schematic view illustrating one exemplary installation configuration of the sofa support leg (25).

FIG. 19 is an exploded view corresponding to one end of the tube body (11) in FIG. 3.

FIG. 20 is an exploded view corresponding to the other end of the tube body (11) in FIG. 3.

FIG. 21 is an exploded view corresponding to FIG. 15.

FIG. 22 is an exploded view corresponding to FIG. 18.

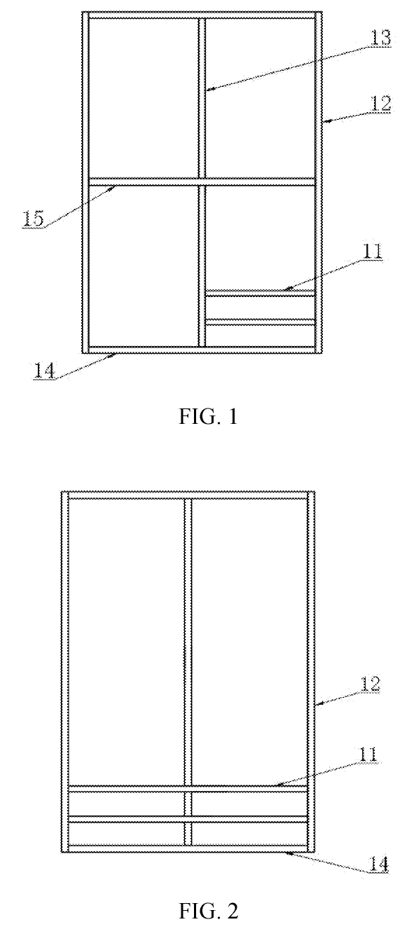

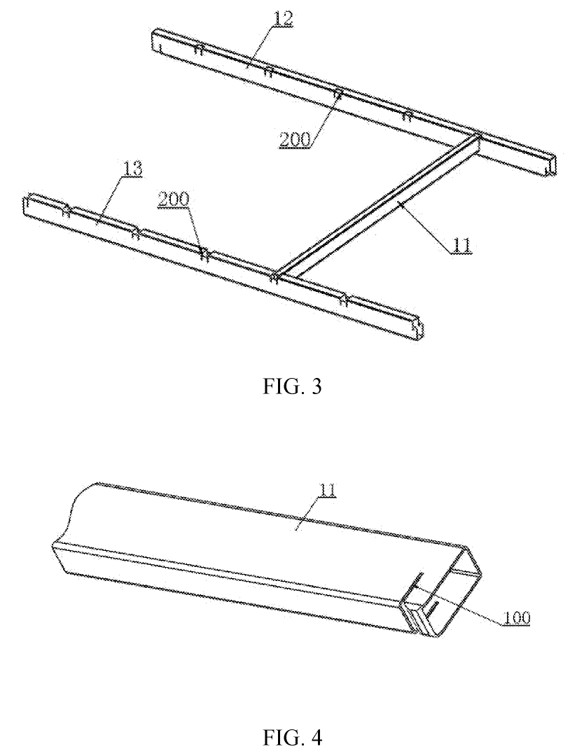

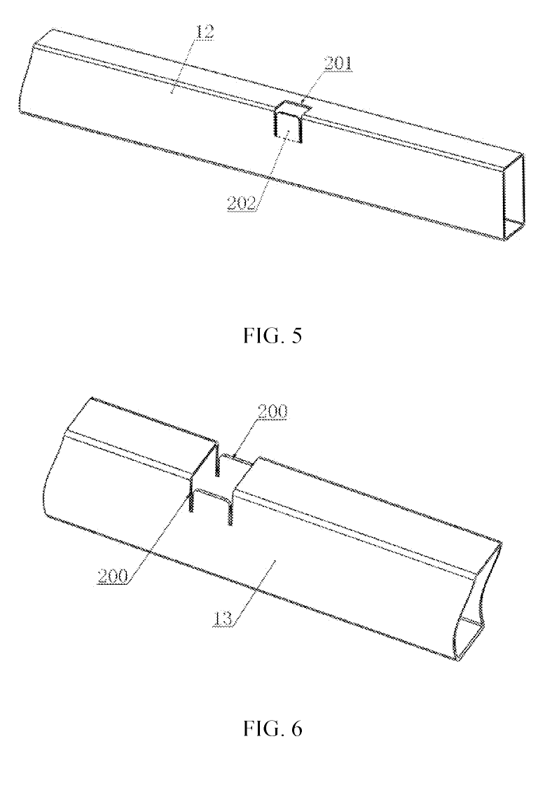

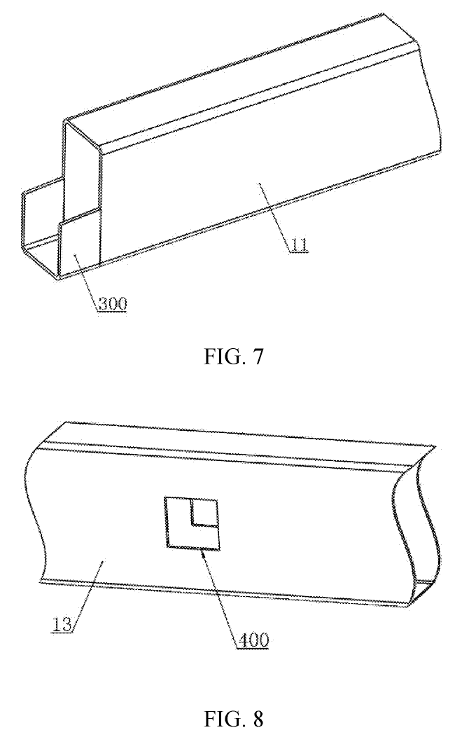

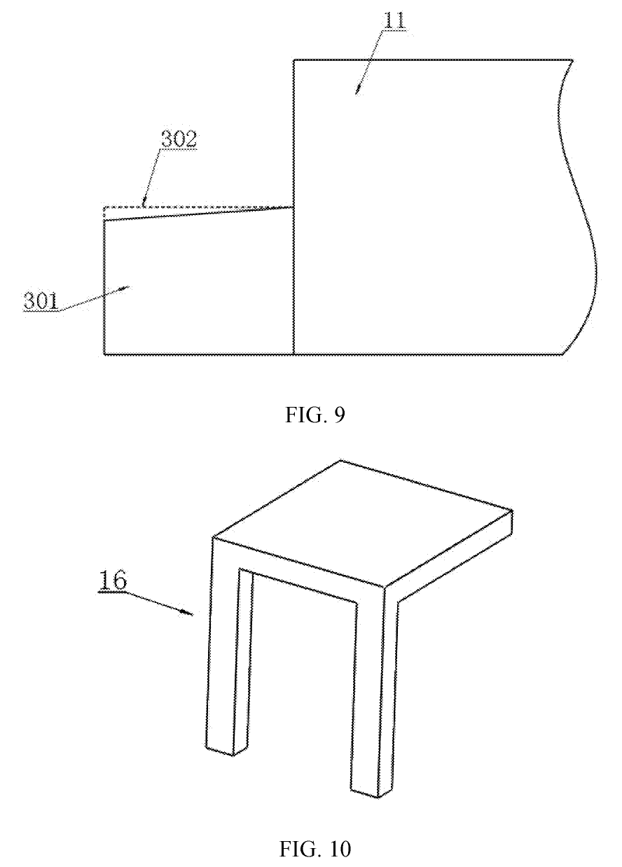

In the drawings, the reference numerals denote the following elements:

side longitudinal beam (12), intermediate longitudinal beam (13), side cross beam (14), intermediate cross beam (15), L-shaped cutout tab (16);

tube body (11);

lower slot (100), inverted L-shaped slot unit (200), oblique-cut latch block unit (300), opening (400);

two-surface slot (201), retaining plate (202), U-shaped block (301), offset oblique-cut (302);

vertical clearance (20), lateral clearance (21);

L-shaped connecting plate (22), corner-reinforcing cross plate (23), threaded hole (24), sofa support leg (25), support leg bolt (26), auxiliary reinforcement threaded hole (27).

### DETAILED DESCRIPTION OF THE EMBODIMENTS

### Embodiment 1

This embodiment is derived from PCT/CN2024/094191.

A reinforcing brace structure for a furniture frame includes a tube body (11), at least one lower slot (100) formed on the bottom plate and two side plates of the tube body (11) at an end thereof, and an inverted L-shaped slot unit (200) provided on the top plate and side plate(s) of the side longitudinal beam (12) and/or the intermediate longitudinal beam (13) for engaging with the lower slot (100).

In this embodiment, the reinforcing brace structure includes: the tube body (11), the lower slot (100), and the inverted L-shaped slot unit (200). The number of lower slots (100) is one or two. The inverted L-shaped slot unit (200) may be provided on the side longitudinal beam (12), the intermediate longitudinal beam (13), extensions of these beams, or even on support legs or supporting frames, as long as the lower slot (100) and the inverted L-shaped slot unit (200) are arranged in mating pairs such that the former can downwardly engage the latter.

The tube body (11) may also be replaced with a solid plate. Prior to replacement, the inverted L-shaped slot unit (200) is formed by cutting out an L-shaped cutout tab (16) corresponding to the retaining plate (202) from the tube body (11); after replacement, it is formed by removing an L-shaped block from the solid plate. Both methods effectively enable engagement with the lower slot (100). Additionally, the vertical depth of the lower slot (100) must be coordinated with the vertical depth of the inverted L-shaped slot unit (200) to ensure that the upper surface of the tube body (11) is flush with the upper surface of the longitudinal beam, thereby enhancing user comfort.

Furthermore, the lateral dimension of the lower slot (100) must match the inward offset of the lower slot (100) from the end face of the tube body (11), so that when the lower slot (100) engages the inverted L-shaped slot unit (200), the end face of the tube body (11) abuts against the side edge of the inverted L-shaped slot unit (200) on the top plate of the longitudinal beam, thereby improving the stability of the tube body (11) at its end.

Correspondingly, the lateral width of the inverted L-shaped slot unit (200) should also correspond to the lateral thickness of the tube body (11), such that the tube body (11) is restrained from movement in all directions except upward within the inverted L-shaped slot unit (200). The reinforcing brace structure further includes an oblique-cut latch block unit (300) provided at the end face of the tube body (11), and an opening (400) formed on the side plate(s) of the side longitudinal beam (12) and/or the intermediate longitudinal beam (13) for receiving the oblique-cut latch block unit (300).

In this embodiment, a first configuration of the tube body (11) features lower slots (100) at both ends. In this case, a row of inverted L-shaped slot units (200) is provided on the inner side plate of the side longitudinal beam (12), and a row of inverted L-shaped slot units (200) is provided on each side plate of the intermediate longitudinal beam (13).

A second configuration of the tube body (11) features an oblique-cut latch block unit (300) at one end and a lower slot (100) at the other end. In this case, one opening (400) and one inverted L-shaped slot unit (200) are respectively provided on the opposing side plates of the side longitudinal beam (12) and the intermediate longitudinal beam (13), or on the opposing side plates of two side longitudinal beams (12).

The lateral positions of the opening (400) and the inverted L-shaped slot unit (200) are not restricted; during installation, the tube body (11) is first inclined to insert the oblique-cut latch block unit (300) into the opening (400), and then rotated downward to engage the lower slot (100) with the inverted L-shaped slot unit (200).

Moreover, for the intermediate longitudinal beam (13), one side may be provided with an inverted L-shaped slot unit (200) while the opposite side is provided with an opening (400).

The inverted L-shaped slot unit (200) includes a two-surface slot (201) configured to receive the end of the tube body (11) from both horizontal and vertical directions.

In this embodiment, the two-surface slot (201) is the space left after removing the L-shaped cutout tab (16) corresponding to the retaining plate (202), and it already provides sufficient engagement with the lower slot (100) for secure fixation.

The inverted L-shaped slot unit (200) further includes a retaining plate (202) provided on the horizontal bottom surface of the two-surface slot (201) and inserted into the lower slot (100).

In this embodiment, the term “retaining” in “retaining plate (202)” refers to a preferred formation method wherein, during removal of the L-shaped cutout tab (16), the vertical portion of the tab is not fully severed but remains connected by narrow strips on both sides—see FIG. 10.

If the width and vertical length of the retaining plate (202) are relatively small, it has negligible effect on the stability of the tube body (11). However, with appropriate dimensions, it can significantly reinforce the tube body (11), which is highly practical.

It should be noted that when the tube body (11) is replaced with a solid plate, an internal cavity must be formed inside the plate beneath the lower slot (100)—not merely a surface cutout—to ensure effective use of the retaining plate (202).

The vertical side surface of the retaining plate (202) is positioned against the inner side surface of the tube body (11).

In this embodiment, the outer side surface of the tube body (11) abuts against the side wall of the two-surface slot (201), providing a first lateral constraint for the tube body (11).

When the width of the retaining plate (202) is suitably large, it can engage the inner side surface of the tube body (11), providing a second lateral constraint and further reinforcing the tube body (11).

The upper surface of the retaining plate (202) is positioned against the inner top surface of the tube body (11).

Similarly, when the “reserved height” of the retaining plate (202) is sufficiently large, it can support the inner top surface of the tube body (11), cooperating with the bottom edge of the two-surface slot (201) that supports the lower slot (100), thereby providing additional vertical reinforcement for the tube body (11).

The oblique-cut latch block unit (300) includes a U-shaped block (301) mounted on the end face of the tube body (11), and an offset oblique-cut (302) provided on the upper surface of the U-shaped block (301) for enabling inclined insertion of the tube body (11) into the opening (400).

In this embodiment, the U-shaped block (301) is preferably formed by leaving a residual portion after an upper-end cut—similar to the retaining plate (202)—rather than by welding a separate U-shaped block (301) onto the original end face of the tube body (11), which would be more cumbersome.

On the other hand, the space between two side longitudinal beams (12), or between a side longitudinal beam (12) and an intermediate longitudinal beam (13), corresponds exactly to the length of the tube body (11). Since the connection between the oblique-cut latch block unit (300) and the opening (400) cannot be installed downward like the lower slot (100) and inverted L-shaped slot unit (200), the installation sequence must be: first incline the tube body (11) to insert the oblique-cut latch block unit (300) into the opening (400), then rotate the tube body (11) downward, and finally snap the lower slot (100) into the inverted L-shaped slot unit (200).

Therefore, the dimensions of the oblique-cut latch block unit (300) and the opening (400) cannot be a tight fit—the offset oblique-cut (302) serves precisely this purpose.

Additionally, the offset oblique-cut (302) may be formed together with the upper-end cut during initial machining, without requiring secondary machining on a rectangular-profile U-shaped block (301).

Finally, if the tube body (11) is replaced with a solid plate, the U-shaped block (301) takes the shape of a right trapezoidal block.

The opening (400) is formed on the side plate of the side longitudinal beam (12) or the intermediate longitudinal beam (13).

In this embodiment, the relationship between the size of the opening (400) and structural strength of the oblique-cut latch block unit (300) exhibits a trade-off; thus, the horizontal and vertical dimensions of the opening (400) are preferably 40–60% of the vertical dimension of the respective longitudinal beam.

The inverted L-shaped slot units (200) are provided in pairs on the intermediate longitudinal beam (13).

In this embodiment, the left and right inverted L-shaped slot units (200) may be staggered and are structurally and functionally independent. The paired inverted L-shaped slot units (200) penetrate through the top plate of the intermediate longitudinal beam (13). In this embodiment, when the two inverted L-shaped slot units (200) are aligned and penetrate the top plate of the intermediate longitudinal beam (13), they are formed by removing a single U-shaped thin steel sheet.

Whether or not the retaining plate (202) is provided in each of the two inverted L-shaped slot units (200), and the specific dimensions of the retaining plate (202), are independently selectable.

### Embodiment 2

Compared with the reinforcing brace structure of Embodiment 1, the only difference in this embodiment is as follows: the upper surface of the retaining plate (202) being positioned against the inner top surface of the tube body (11) is replaced by: a vertical clearance (20) being defined between the upper surface of the retaining plate (202) and the inner top surface of the tube body (11).

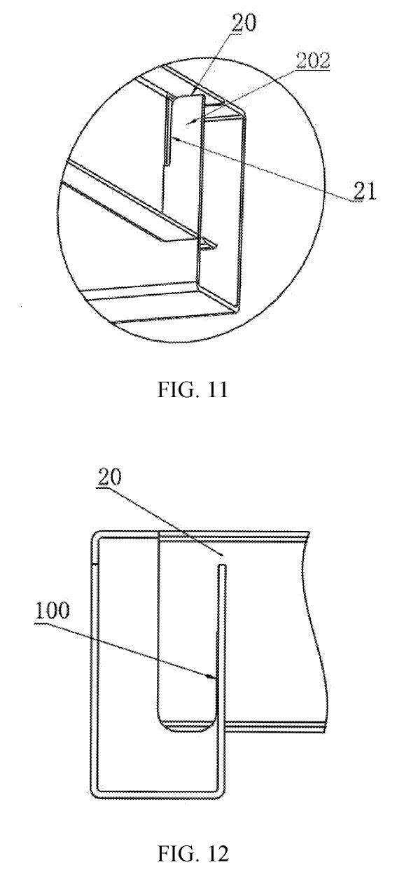

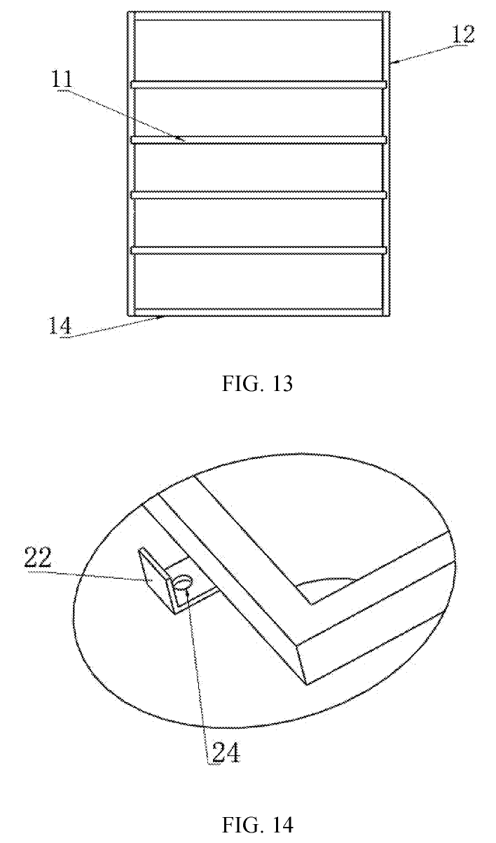

In this embodiment, both the upper surface of the retaining plate (202) and the inner top surface of the tube body (11) are horizontally oriented, and the distance therebetween is 2.0–5.0 mm—see FIGS. 11 and 12. This design primarily aims to reduce the machining precision required at the retaining plate (202), thereby lowering manufacturing difficulty.

If the retaining plate (202) were to directly support the inner top surface of the tube body (11) and its vertical dimension were accidentally oversized, the entire load on the tube body (11) would concentrate on the two retaining plates (202), resulting in an unstable installation state.

Furthermore, in this embodiment, both ends of the tube body (11) are connected via engagement between the lower slot (100) and the inverted L-shaped slot unit (200), without using the oblique-cut latch block unit (300) and opening (400).

### Embodiment 3

Compared with the reinforcing brace structure of Embodiment 1, the only difference in this embodiment is as follows: the vertical side surface of the retaining plate (202) being positioned against the inner side surface of the tube body (11) is replaced by: a lateral clearance (21) being defined between the vertical side surface of the retaining plate (202) and the inner side surface of the tube body (11).

In this embodiment, both the vertical side surface of the retaining plate (202) and the inner side surface of the tube body (11) are vertically oriented, and the distance therebetween is 1.0–3.0 mm—see FIG. 11. This design primarily aims to reduce the machining precision required at the retaining plate (202), thereby lowering manufacturing difficulty.

If the vertical side surface of the retaining plate (202) were to abut the inner side surface of the tube body (11) and the width of the retaining plate (202) were too large, the tube body (11) would be difficult to insert downward—a condition to be avoided.

Furthermore, in this embodiment, both ends of the tube body (11) are connected via engagement between the lower slot (100) and the inverted L-shaped slot unit (200), without using the oblique-cut latch block unit (300) and opening (400).

### Embodiment 4

Compared with the reinforcing brace structure of Embodiment 1, this embodiment differs in the following two aspects: First, the upper surface of the retaining plate (202) being positioned against the inner top surface of the tube body (11) is replaced by: a vertical clearance (20) being defined between the upper surface of the retaining plate (202) and the inner top surface of the tube body (11).

Second, the vertical side surface of the retaining plate (202) being positioned against the inner side surface of the tube body (11) is replaced by: a lateral clearance (21) being defined between the vertical side surface of the retaining plate (202) and the inner side surface of the tube body (11).

### Embodiment 5

Compared with the reinforcing brace structure of Embodiment 1, the only difference in this embodiment is as follows: newly added is the feature that the two opposing side surfaces of the lower slot (100) are respectively positioned on the two side surfaces of the vertical plate regions of the side longitudinal beam (12) and/or the intermediate longitudinal beam (13) located below the two-surface slot (201).

In this configuration, the tube body (11) obtains not only longitudinal end-stop limitation at its end face but also longitudinal end-stop limitation at the lower slot (100). Moreover, while the former provides only unidirectional limitation (e.g., ineffective when two side longitudinal beams (12) move apart, allowing the tube body (11) to fall), the latter provides bidirectional limitation: the vertical plate region contacts the lower slot (100) on both sides, thereby preventing the side longitudinal beams (12) from either moving apart or moving closer together.

Ultimately, an appropriate slot width at the lower slot (100) further enhances the stability of the reinforcing brace structure and the overall sofa frame.

### Embodiment 6

This embodiment further provides a sofa including any one of the reinforcing brace structures of Embodiments 1–5, or a combination of different styles thereof.

Additionally, the sofa includes side cross beams (14) and side longitudinal beams (12), which together form a sofa seat frame. The number of sofa seat frames is two or more.

### Embodiment 7

Based on Embodiment 6, the sofa of this embodiment further includes L-shaped connecting plates (22) mounted on the lower surfaces of the side cross beams (14) or side longitudinal beams (12) for hooking and connecting adjacent sofa seat frames. The L-shaped connecting plates (22) interconnect adjacent sofa seat frames into an integral assembly, thereby reducing the required connection strength at the joint between the lower slot (100) and the inverted L-shaped slot unit (200).

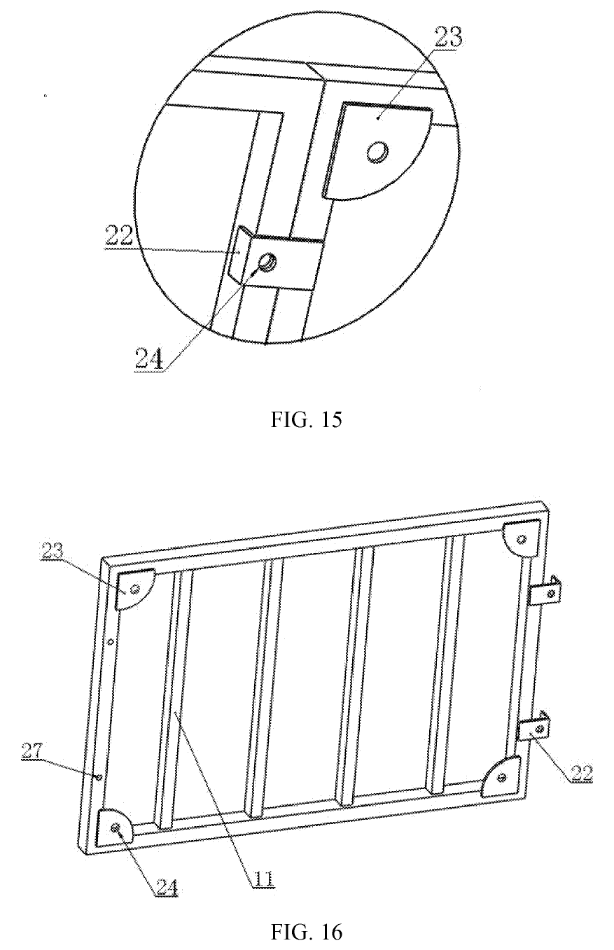

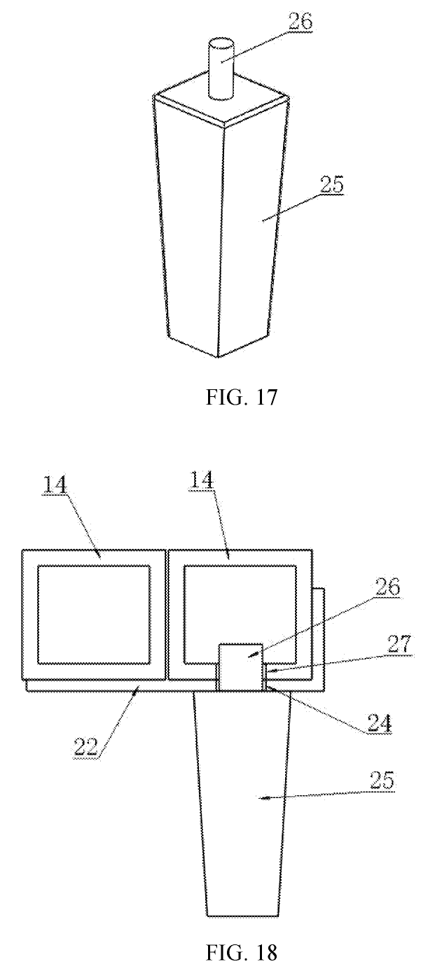

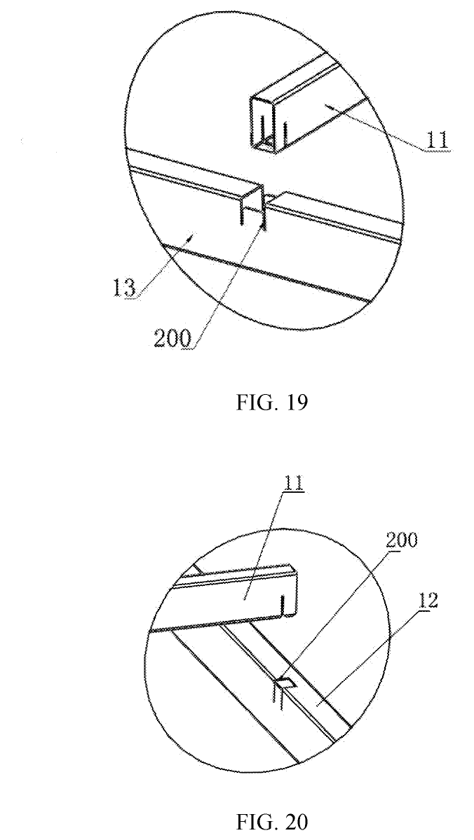

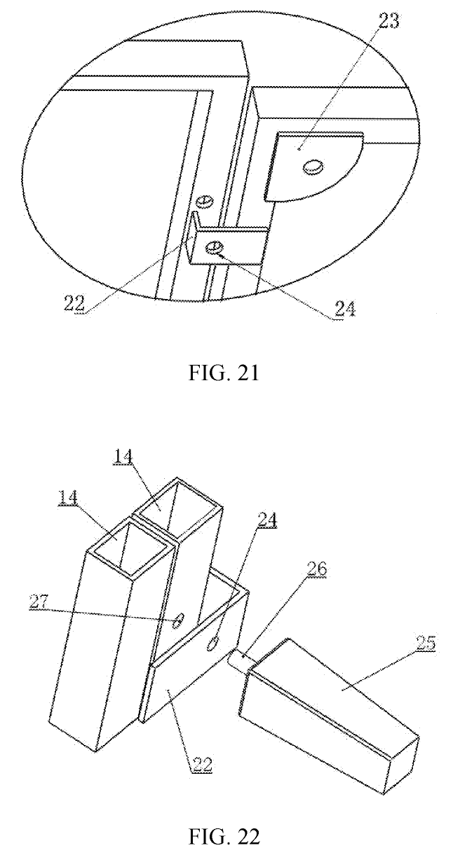

In this embodiment, each L-shaped connecting plate (22) includes a horizontal flange and an upward-extending vertical flange. When 2–3 sofa seat frames are sequentially assembled, the side cross beams (14) of adjacent frames abut each other. The horizontal flange is welded to the lower surface of one side cross beam (14), and the vertical flange provides vertical support and lateral restraint for the adjacent side cross beam (14), thereby relatively fixing the two adjacent sofa seat frames—see FIGS. 14, 15, and 18.

Additionally, three points warrant special mention: First, for a rectangular sofa seat frame, one purpose of the tube body (11) is to maintain the rectangular geometry and prevent angular deformation at the joints between the side cross beams (14) and side longitudinal beams (12). Second, with the L-shaped connecting plates (22), 2–3 sofa seat frames are integrated into a single structure, allowing lateral loads on the sofa to be distributed; thus, the L-shaped connecting plates (22) and the tube body (11) jointly enhance the structural stability of the sofa seat frame and the sofa as a whole. Third, from another perspective, while the lower slot (100) and inverted L-shaped slot unit (200) constitute the primary anti-deformation structure of the sofa seat frame, the addition of the L-shaped connecting plates (22) significantly reduces the connection strength required from this anti-deformation structure, thereby extending its service life.

### Embodiment 8

Based on Embodiment 7, the sofa of this embodiment further includes corner-reinforcing cross plates (23) mounted on the sofa seat frame for connecting adjacent side cross beams (14) and side longitudinal beams (12).

In this embodiment, one sofa seat frame includes four corner-reinforcing cross plates (23), which are shaped as sectors or rectangles. Similar to the L-shaped connecting plates (22), the primary function of the corner-reinforcing cross plates (23) is to maintain the rectangular geometry of the sofa seat frame and cooperate with the engagement structure formed by the lower slot (100) and inverted L-shaped slot unit (200) to provide mutual reinforcement.

The corner-reinforcing cross plates (23) are welded to the lower surfaces of one side cross beam (14) and one adjacent side longitudinal beam (12) that are joined end-to-end.

### Embodiment 9

Based on Embodiment 8, the sofa of this embodiment is further defined such that the horizontal flange of the L-shaped connecting plate (22) and/or the corner-reinforcing cross plate (23) is provided with threaded holes (24), and sofa support legs (25) are mounted in the threaded holes (24).

In this embodiment, sofa support legs (25) are provided on both the L-shaped connecting plates (22) and the corner-reinforcing cross plates (23), enabling the sofa to have both side support legs and central support legs, thereby further enhancing support stability.

Specifically, the thickness of the corner-reinforcing cross plate (23) is identical to the thickness of the horizontal flange of the L-shaped connecting plate (22), allowing both to accommodate sofa support legs (25) of the same size specification.

### Embodiment 10

Based on Embodiment 9, the sofa of this embodiment is further defined such that the lower surfaces of the side cross beams (14) or side longitudinal beams (12) are provided with auxiliary reinforcement threaded holes (27) aligned with the threaded holes (24), which cooperate with the threaded holes (24) to mount support leg bolts (26).

In this embodiment, when the sofa includes two sofa seat frames, one frame is provided with a set of L-shaped connecting plates (22), and the other frame is provided with a set of auxiliary reinforcement threaded holes (27).

When the number of sofa seat frames is three or more, at least one of the sofa seat frames has a set of L-shaped connecting plates (22) on one side cross beam (14) and a set of auxiliary reinforcement threaded holes (27) on the other side cross beam (14).

In this configuration, for any two adjacent sofa seat frames, the sofa support leg (25) is directly screwed into one frame and indirectly screwed into the other via the auxiliary reinforcement threaded hole (27). Thus, the provision of the auxiliary reinforcement threaded holes (27) further enhances the structural integrity and support stability of the sofa.

What is claimed is:

1. A reinforcing brace structure for a furniture frame, comprising:
a tube body;
at least one lower slot provided at an end of the tube body and formed on a bottom plate and two side plates of the tube body; and
an inverted L-shaped slot unit provided on a top plate and side plate(s) of a side longitudinal beam and/or an intermediate longitudinal beam, wherein the inverted L-shaped slot unit is configured to engage with the lower slot.

2. The reinforcing brace structure for the furniture frame according to claim 1, further comprising:
an oblique-cut latch block unit provided at an end face of the tube body; and
an opening provided on a side plate of the side longitudinal beam and/or the intermediate longitudinal beam, wherein the opening is configured to receive the oblique-cut latch block unit.

3. The reinforcing brace structure for the furniture frame according to claim 1, wherein the inverted L-shaped slot unit comprises a two-surface slot configured to receive an end of the tube body from both horizontal and vertical directions.

4. The reinforcing brace structure for the furniture frame according to claim 3, wherein the inverted L-shaped slot unit further comprises a retaining plate provided on a horizontal bottom surface of the two-surface slot and inserted into the lower slot.

5. The reinforcing brace structure for the furniture frame according to claim 4, wherein a vertical side surface of the retaining plate is positioned against an inner side surface of the tube body.

6. The reinforcing brace structure for the furniture frame according to claim 4, wherein an upper surface of the retaining plate is positioned against an inner top surface of the tube body.

7. The reinforcing brace structure for the furniture frame according to claim 2, wherein the oblique-cut latch block unit comprises:
a U-shaped block mounted on an end face of the tube body; and
an offset oblique-cut provided on an upper surface of the U-shaped block, wherein the offset oblique-cut is configured to enable inclined insertion of the tube body into the opening.

8. The reinforcing brace structure for the furniture frame according to claim 2, wherein the opening is formed on a side plate of the side longitudinal beam or the intermediate longitudinal beam.

9. The reinforcing brace structure for the furniture frame according to claim 1, wherein the inverted L-shaped slot units are provided in pairs on the intermediate longitudinal beam.

10. The reinforcing brace structure for the furniture frame according to claim 9, wherein the pair of inverted L-shaped slot units penetrate through a top plate of the intermediate longitudinal beam.

11. The reinforcing brace structure for the furniture frame according to claim 4, wherein a vertical clearance is defined between an upper surface of the retaining plate and an inner top surface of the tube body.

12. The reinforcing brace structure for the furniture frame according to claim 4, wherein a lateral clearance is defined between a vertical side surface of the retaining plate and an inner side surface of the tube body.

13. The reinforcing brace structure for the furniture frame according to claim 3, wherein two opposing side surfaces of the lower slot are respectively positioned on two side surfaces of vertical plate regions of the side longitudinal beam and/or the intermediate longitudinal beam located below the two-surface slot.

14. The reinforcing brace structure for the furniture frame according to claim 1, wherein the furniture frame is a sofa.

15. The reinforcing brace structure for the furniture frame according to claim 14, wherein the sofa further comprises side cross beams and the side longitudinal beams, and the side cross beams and the side longitudinal beams together form a sofa seat frame.

16. The reinforcing brace structure for the furniture frame according to claim 15, wherein a number of sofa seat frames is two or more.

17. The reinforcing brace structure for the furniture frame according to claim 16, wherein the sofa further comprises L-shaped connecting plates mounted on lower surfaces of the side cross beams or the side longitudinal beams, wherein the L-shaped connecting plates are configured to hook and connect adjacent sofa seat frames; the L-shaped connecting plates interconnect adjacent sofa seat frames into an integral assembly, thereby reducing a connection strength required at a joint between the lower slot and the inverted L-shaped slot unit.

18. The reinforcing brace structure for the furniture frame according to claim 17, wherein the sofa further comprises corner-reinforcing cross plates mounted on the sofa seat frame and configured to connect adjacent side cross beams and side longitudinal beams.

19. The reinforcing brace structure for the furniture frame according to claim 18, wherein a horizontal portion of the L-shaped connecting plate and/or the corner-reinforcing cross plate is provided with threaded holes, and sofa support legs are mounted in the threaded holes.

20. The reinforcing brace structure for the furniture frame according to claim 19, wherein lower surfaces of the side cross beams or the side longitudinal beams are provided with auxiliary reinforcement threaded holes aligned with the threaded holes, and the auxiliary reinforcement threaded holes cooperate with the threaded holes to mount support leg bolts.
